(19) United States
(12) Patent Application Publication
(10) Pub. No.: US 2023/0308731 A1
(43) Pub. Date: Sep. 28, 2023

(54) METHOD FOR PROVIDING SERVICE OF PRODUCING MULTIMEDIA CONVERSION CONTENT BY USING IMAGE RESOURCE MATCHING, AND APPARATUS THEREOF

(71) Applicant: Wayne Hills Bryant A.I Co., Ltd., Seoul (KR)

(72) Inventor: Soo Min LEE, Gimpo-si (KR)

(21) Appl. No.: 18/328,700

(22) Filed: Jun. 2, 2023

Related U.S. Application Data
(63) Continuation of application No. PCT/KR2021/018046, filed on Dec. 1, 2021.

(30) Foreign Application Priority Data
Dec. 4, 2020 (KR) 10-2020-0168382

(51) Int. Cl. H04N 21/854; G10L 13/08; G06F 16/783

(52) U.S. Cl. CPC H04N 21/854; G10L 13/08; G06F 16/783

(57) ABSTRACT

A method according to an embodiment of the present invention is a method for operating a service providing apparatus, the method comprising the steps of: inputting data to be converted; extracting element information from the data to be converted; providing a production interface on the basis of video resource matching corresponding to the element information; performing multimedia content synthesis and conversion processing according to user inputs to the production interface, so as to obtain multimedia conversion content; and outputting the multimedia conversion content.

### CROSS-REFERENCE TO RELATED APPLICATIONS

This application is a continuation of pending PCT International Application No. PCT/KR2021/018046, filed on Dec. 1, 2021, which claims priority to Korean Patent Application No. 10-2020-0168382, filed on Dec. 4, 2020, the entire contents of which are hereby incorporated by references in its entirety.

### TECHNICAL FIELD

The present invention relates to a service providing method and apparatus, more specifically to a method and apparatus for providing a converted multimedia content producing service using video resource matching.

### BACKGROUND ART

With the development of video and content production technologies, recently, personalized various multimedia content have been produced and distributed through social networking service, and the like. A multimedia content sharing service representatively known as YouTube exponentially increases in the number of producer and users, and further, various specialized tools for video content production have been developed to enhance the conveniences of users.

However, the use of the specialized tools is not convenient yet. To produce a high quality of multimedia content, the time and technology labor of a specialist who well handles the specialized tools has to be required, and further, it is difficult to receive materials for the production, which undesirably raises a production cost.

In specific, such problems obviously happen in a work for converting existing text format documents into multimedia content for enhancing information-conveying ability. If the text document such as general report is produced to video content, therefore, collection of related video materials, use of specialized tools, and technology labor and time of a specialist are excessively required.

### DISCLOSURE

### Technical Problem

Accordingly, it is an object of the present invention to provide a content production service providing method and apparatus that is capable of performing resource matching, conversion, and processing for subject data such as general documents, not multimedia content format, according to pre-setting and learned analysis process, so that the subject data-based converted multimedia content can be produced easily and rapidly, without having any separate professional tools or any participation of a specialist.

### Technical Solution

To accomplish the above-mentioned object, according to an aspect of the present invention, a method for operating a service providing apparatus may include the steps of: receiving subject data to be converted; extracting element information from the subject data; performing multimedia content synthesis and conversion based on video resource matching to the element information to acquire converted multimedia content; and outputting the converted multimedia content.

To accomplish the above-mentioned object, according to another aspect of the present invention, a service providing apparatus may include: an input unit for receiving subject data to be converted; an element information extraction unit for extracting element information from the subject data; a content synthesis and conversion unit for performing multimedia content synthesis and conversion based on video resource matching to the element information to acquire converted multimedia content; and an output unit for outputting the converted multimedia content.

To accomplish the above-mentioned object, according to yet another aspect of the present invention, the method according to the present invention is provided to the form of a program for executing the method in a computer and a recording medium in which the program is recorded.

### Advantageous Effects of the Invention

According to the present invention, if the subject data to be converted is inputted, the element information is extracted from the subject data, and next, the production interface is provided according to the video resource matching to the element information to perform the multimedia content synthesis and conversion according to the user inputs to the production interface, thereby conveniently producing the multimedia content converted from the subject data.

Accordingly, the service providing apparatus according to the present invention can perform the resource matching, conversion, and processing for the subject data such as general documents, not multimedia content format, according to pre-setting and learned analysis process, so that the subject data-based converted multimedia content can be produced easily and rapidly, without having any separate professional tools or any participation of a specialist.

### BRIEF DESCRIPTION OF DRAWINGS

FIG. 1 is a schematic block diagram showing a whole system according to the present invention.

FIG. 2 is a block diagram showing a service providing apparatus according to the present invention.

FIG. 3 is a flowchart showing operations of the service providing apparatus according to the present invention.

FIG. 4 is an exemplary view showing synthesized and converted video multimedia content according to the present invention.

FIG. 5 is an exemplary view showing a process where input data is converted into multimedia content data according to the present invention.

FIGS. 6 and 7 are block diagrams showing resource database according to the present invention.

FIG. 8 is an exemplary view showing a production interface according to the present invention.

### MODE FOR DISCLOSURE

While this invention is illustrated and described in a preferred embodiment, the device may be produced in many different configurations, forms, and materials. There is depicted in the drawings, and will hereinafter be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

It should be understood that detailed explanations on the principle, view and embodiment of the present invention may include structural and functional equivalents thereof. Further, it should be appreciated that such equivalents may include currently known equivalents as well as equivalents to be developed in the future, that is, all of devices that are invented to perform the same functions, irrespective of structures thereof.

For example, it should be understood that a block diagram in the present invention shows a conceptual view of an exemplary circuit explaining the principle of the present invention. Similarly, all flowcharts, state transition diagrams, and pseudo codes substantially appear on a computer readable medium, and they indicate various processes performed by a computer or processor, irrespective of whether the computer or processor is obviously shown.

Further, the terms suggested as processor, control, or concepts similar to the process and control should be not analyzed through exclusive citation of hardware having the ability of executing software, and it should be understood that they implicitly include Digital Signal processor (DSP) hardware and ROM, RAM and non-volatile memory for storing software. Of course, they may include well-known and commonly used other hardware.

Objects, characteristics and advantages of the present invention will be more clearly understood from the detailed description as will be described below and the attached drawings, and it is to be appreciated that those skilled in the art can change or modify the embodiments without departing from the scope and spirit of the present invention. If it is determined that the detailed explanation on the well-known technology related to the present invention makes the scope of the present invention not clear, the explanation will be avoided for the brevity of the description.

Hereinafter, embodiments of the present invention will be explained in detail with reference to the attached drawings.

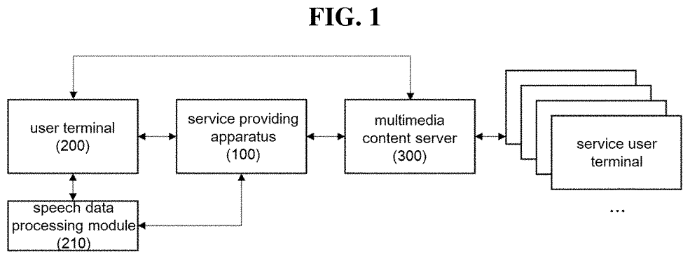

FIG. 1 is a schematic block diagram showing a whole system according to the present invention.

Referring to FIG. 1, a whole system according to the present invention includes a service providing apparatus 100, a user terminal 200, and a multimedia content server 300.

The service providing apparatus 100 according to the present invention receives subject data to be converted from the user terminal 200, processes the subject data as input data, performs multimedia content conversion based on resource matching to element information corresponding to the subject data, and outputs the converted multimedia content to the multimedia content server 300 from which the multimedia content is distributed to one or more service user terminals.

In specific, if the service providing apparatus 100 receives the subject data to be converted from the user terminal 200, the service providing apparatus 100 extracts the element information from the subject data, provides a production interface based on video resource matching to the element information to the user terminal 200, performs multimedia content synthesis and conversion according to user inputs to the production interface, acquires converted multimedia content, and outputs the converted multimedia content to the multimedia content server 300.

As a result, the converted multimedia content of the subject data inputted is distributed to one or more service user terminals through the multimedia content server 300, and the multimedia content server 300 performs various information providing services based on the converted multimedia content.

The user terminal 200, the service providing apparatus 100, and the multimedia content server 300 are connected wiredly or wirelessly to one another through networks, and to perform their communication on the networks, the user terminal 200, the service providing apparatus 100, and the multimedia content server 300 transmit and receive data from and to one another through internet network, LAN, WAN, Public Switched Telephone Network (PSTN), Public Switched Data Network (PSDN), cable TV network, WiFi, mobile communication network, and other wireless communication networks. The user terminal 200, the service providing apparatus 100, and the multimedia content server 300 include respective communication modules for performing the communication through protocols corresponding to their communication networks.

Further, the user terminal 200 as described in the present invention includes a cellular phone, a smart phone, a laptop computer, a digital broadcasting terminal, Personal Digital Assistants (PDA), Portable Multimedia Player (PMP), navigation, and the like, but the user terminal 200 may include various devices through which user inputs and information display are performed, without being limited thereto.

In such a whole system, the user terminal 200 receives the multimedia content conversion service based on the resource matching to the input data from the service providing apparatus 100 and additionally receives additional information service based on the converted multimedia content from the service providing apparatus 100.

To extract the element information, in specific, the service providing apparatus 100 extracts text-based key element information according to the pattern and statistical similarity of the conversion subject input data through a predetermined natural language processing algorithm, performs resource matching through which video, image, text, animation, font (color and size), and audio are optimizedly matched by frame merging layer to the extracted text-based element information, provides the production interface using the matched element information, and produces the frame merging layer-based optimizedly converted multimedia content according to the user inputs to the production interface.

Even if general document or image data with various formats, such as market report, statistics report, company profile, commercial advertising paper, resume, cover latter, and the like are received, accordingly, the service providing apparatus 100 according to the present invention performs the video content resource matching to the extracted element information through element analysis and thus produces the multimedia video content through the optimized frame merging easily and rapidly, thereby greatly reducing the professional labor, cost, and time required for multimedia video content production. Even an amateur in video editing can produce general document-based multimedia video content according to the matching proposal of the service providing apparatus 100.

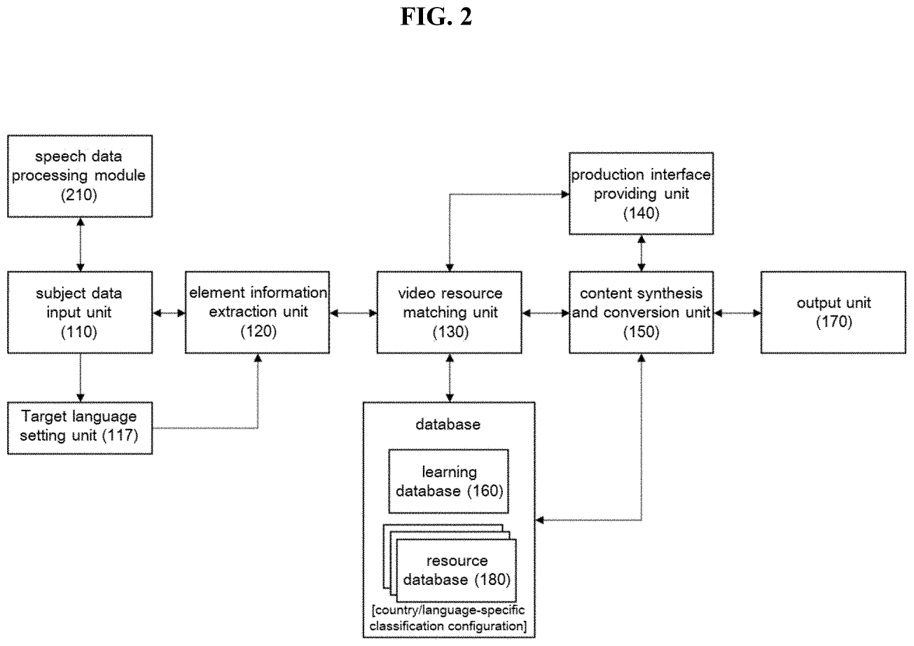

FIG. 2 is a block diagram showing the service providing apparatus according to the present invention.

Referring to FIG. 2, the service providing apparatus 100 according to the present invention includes a subject data input unit 110, an element information extraction unit 120, a video resource matching unit 130, a production interface providing unit 140, a content synthesis and conversion unit 150, a learning database 160, a resource database 180, and an output unit 170.

First, the input unit 110 receives the subject data for the multimedia content conversion from the user terminal 200 and transmits the subject data to the element information extraction unit 120.

The input unit 110 includes one or more input interfaces for receiving the subject data from the user terminal 200. For example, the subject data may be document data received from the user terminal 200, and the document data is data with various formats, such as report, company profile, cover letter, commercial advertisement document, and the like. Further, the subject data may include newspaper articles, social networking service (SNS) document, and the like which are extracted from specific sites.

Further, the input unit 110 processes format identification for the subject data received from the user terminal 200, and the processed format identification information is transmitted to the element information extraction unit 120. For example, the format identification information represents various types of documents, such as novel, essay, newspaper article, draft, proposal, plan, business report, settling accounts, meeting report, and the like.

Furthermore, the input unit 110 receives main element data corresponding to the subject data. For example, the main element data represents keywords, type of report, information of company characteristics, main enterprise name, main company name, main character name, and the like, which are received from the user terminal 200, and upon the element information extraction of the element information extraction unit 120, a weight value corresponding to the main element data may be applied.

The element information extraction unit 120 extracts the element information from the received subject data so that the subject data is divided into one or more element data to which video resources are matched.

In this case, the element information extraction is performed by extracting the element data of test format from the subject data using the predetermined natural language processing algorithm, and the extracted element information is transmitted to the video resource matching unit 130.

In specific, the element information extraction unit 120 determines a natural language processing process of the subject data to match the subject data to the video resources, based on the main element data and the format identification information of the subject data. In this case, the natural language processing process is a pre-learned text summarization process through deep learning.

Accordingly, the element information extraction unit 120 performs the text summarization process to extract key sentences or words from the subject data and thus synthesize the sentences or words, and next, the element information extraction unit 120 outputs the synthesized sentences or words as the element information.

In determining the text summarization process, further, the element information extraction unit 120 applies one or more different language models according to the format identification information of the subject data. The language models may be extraction models or synthesis models, and different models may be determined according to company characteristics and types of documents.

For example, if large or medium-sized company information is included in the main element information received correspondingly to the subject data, the element information extraction unit 120 applies the extraction model to the subject data according to the format identification information of large quantities of documents such as reports, terms and conditions, and the like and thus extracts the key sentence information from the original text, as the element information.

Further, if small business, start-up, or creator information is included in the main element information received correspondingly to the subject data, the element information extraction unit 120 applies the synthesis model to the subject data according to the format identification information of small quantities of documents such as newspaper column, lecture notes, lifestyle materials, and the like, sorts keyword information from the original text, and thus extracts the sentence information synthesized to one summarized sentence as the element information.

Accordingly, the element information includes one or more key sentence information extracted from the subject data or acquired based on the synthesized language model. The sentence information corresponds to a layer unit of one video resource matching frame, and appropriate resource matching by sentence information is processed to constitute one video frame layer unit.

Further, the video resource matching unit 130 performs the optimized resource matching to the element information, based on a learning database 160 and a resource database 180, and transmits the resource matching information to the content synthesis and conversion unit 150 and the production interface providing unit 140.

In more specific, the video resource matching unit 130 performs the resource matching processing for the content synthesis and conversion corresponding to the element information, and resources for the content synthesis and conversion include various content, such as background video, background image, background music, layout, motion, animation, and the like, which are processed in predetermined frame layer unit or pre-stored in the resource database 180.

Further, the resource database 180 stores and manages the resource content data received from various content servers connected thereto through external networks. In this case, the resource content data includes at least one of content attribute information, content identification information, content link information, and content data information, and the matched resource information is transmitted to the production interface providing unit 140 or the content synthesis and conversion unit 150.

Further, the video resource matching unit 130 builds and utilizes the learning database 160 to match the resource content of the resource database 180 to the element information more appropriately. The learning database 160 builds a relation learning model for learning relation information between the resource content and the element information, and weight value variables are set to match the resource content to the type and main element information of the subject data more appropriately. Accordingly, the video resource matching unit 130 utilizes the learning database 160 to calculate the matching information obtained by matching optimal resource content to the element information, and the calculated matching information is transmitted to the production interface providing unit 140 and the content synthesis and conversion unit 150.

For example, the video resource matching unit 130 matches background, sounds, font types, and the like corresponding to the sentence information of the element information by video frame layer unit which are divided in given time unit to the pre-built resource database 180, based on the learning database 160.

The learning database 160 defines a main category and a sub category of the sentence information and analyzes the correlation of the deep learning results of the main category and the sub category, so that a degree of stochastic correlation of the matched background, sounds or font types with a business purpose corresponding to the format of the subject document can be arithmetically analyzed.

Accordingly, the video resource matching unit 130 acquires the resource content such as background, sounds or font types, from which the most optimized correlation is calculated, as the matching information to the video frame layer unit.

According to the present invention, further, the video resource matching unit 130 directly produces image or audio resource content depicting the sentence of the element information or searches it from the resource database 180, and the produced or searched resource content is transmitted to the production interface providing unit 140 and the content synthesis and conversion unit 150.

Further, the production interface providing unit 140 makes the production interface for synthesizing and converting the matched content through the video resource matching unit 130, based on the matching information, and provides the production interface to the user terminal 200.

The production interface providing unit 140 transmits the resource content data and the resource matching information to an interface application executed in the user terminal 200 or to the user terminal 200 through a separate API. Otherwise, the production interface providing unit 140 makes a real-time web production interface based on the resource content data and the resource matching information and provides it to the user terminal 200.

Accordingly, the user terminal 200 checks the resource content in which the element information is extracted from the subject data inputted by the user and matched to the video resources, performs appropriate editing and processing, and inputs synthesis and conversion commands. Further, the user terminal 200 is set so that a conversion request is directly inputted to the content synthesis and conversion unit 150, without any separate editing and processing therein.

The content synthesis and conversion unit 150 performs the synthesis and conversion of the subject data into the multimedia content, based on the resource content data and the resource matching information and the input information of the user terminal 200.

Accordingly, the converted multimedia content includes multimedia data having at least one of video, sound, image, animation, caption, and font synthesized and converted from the subject data. The synthesized and converted multimedia content is provided to the production interface providing unit 140 and then transmitted to the output unit 170 according to the checking or uploading input of the production interface providing unit 140.

The output unit 170 outputs the finally determined multimedia content as the conversion content of the subject data, and the converted multimedia content is provided to the multimedia content server 300 so that it is used for various information providing services based on the subject data and shared with one or more other user terminals through social networking service.

For example, the information providing services include multimedia content conversion services utilizing various document data such as newspaper article, report, novel, essay, blog, and the like, and further, the information providing services include multimedia content streaming services.

Further, the service providing apparatus 100 according to the present invention performs the synthesis and conversion of report data with relatively long sentences as well as all kinds of newsletters, online comments, and SNS data with relatively short sentences into multimedia content through the video resource matching to the extracted element information.

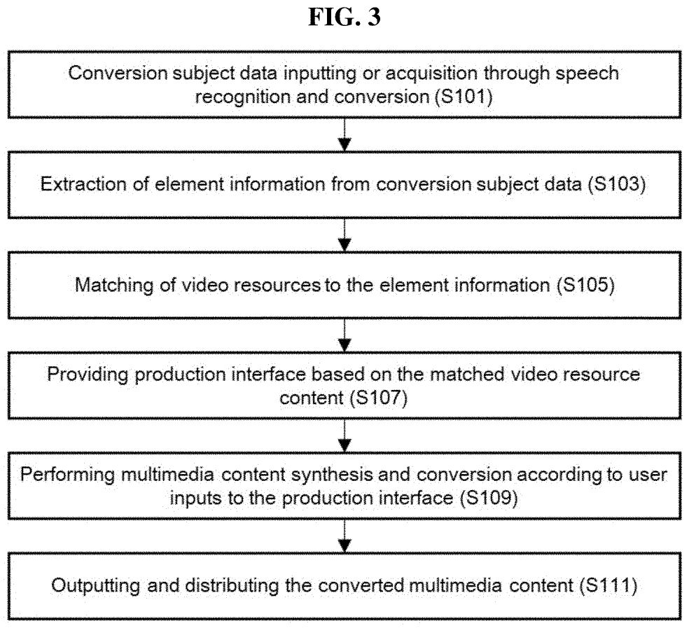

FIG. 3 is a flowchart showing operations of the service providing apparatus according to the present invention.

Referring to FIG. 3, the service providing apparatus 100 receives the subject data to be converted from the user terminal 200 (at step S101).

Next, the service providing apparatus 100 extracts the element information from the subject data (at step S103).

After that, the service providing apparatus 100 processes the video resource matching to the element information (at step S105).

The service providing apparatus 100 provides the production interface based on the matched video resource content to the user terminal 200 (at step S107).

Next, the service providing apparatus 100 performs the multimedia content synthesis and conversion according to the user inputs to the production interface (at step S109).

After that, the service providing apparatus 100 outputs and distributes the converted multimedia content (at step S111).

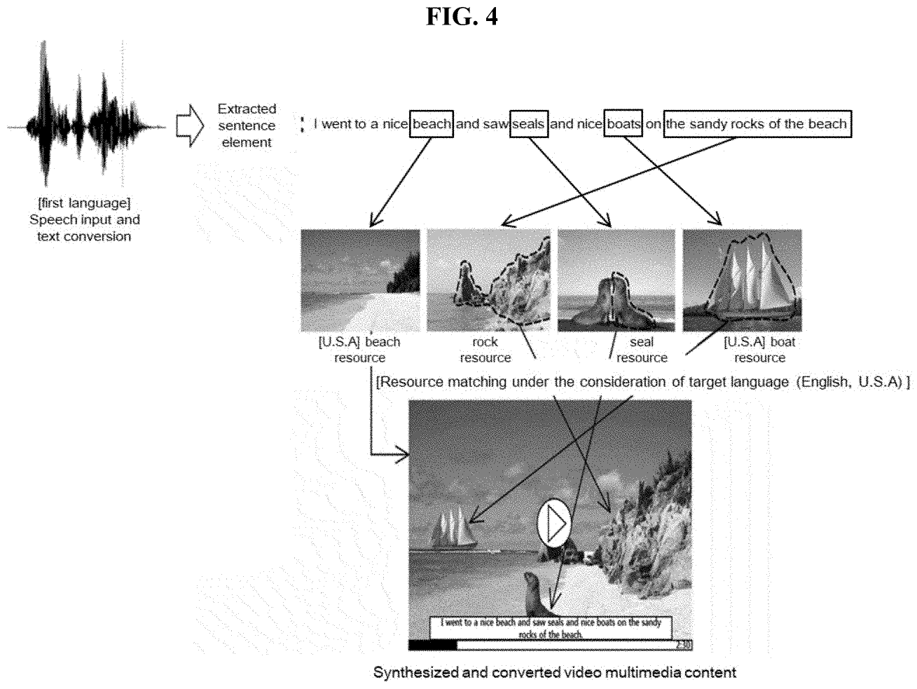

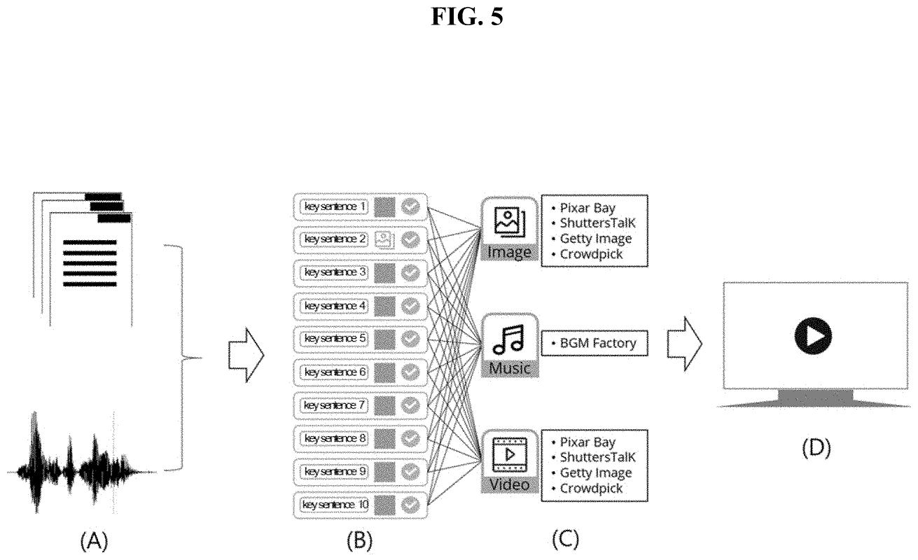

FIG. 4 is an exemplary view showing synthesized and converted video multimedia content according to the present invention, and FIG. 5 is an exemplary view showing a process where input data is converted into multimedia content data according to the present invention.

Referring first to FIG. 4, as described above, the element information extraction unit 120 extracts a sentence “I went to a nice beach and saw seals and nice boats on the sandy rocks of the beach” as element information from the subject data.

Further, the video resource matching unit 130 acquires the most adequate resource content corresponding to the keywords of the extracted element information from the resource database 180, based on the learning database 160. For example, a beach video resource is matched to the keyword ‘beach’, a rock video resource to the keyword ‘the sandy rocks of the beach’, a seal video resource to the keyword ‘seals’, and a boat video resource to the keyword ‘boats’.

Further, the video resource matching unit 130 matches caption and font resources to the sentence information as the element information and matches the audio made by converting the sentence information into speech as a sound resource to the sentence information. Furthermore, the video resource matching unit 130 matches animation information to the sentence information.

Accordingly, the content synthesis and conversion unit 150 produces the multimedia video content whose video resources, caption and font resource, sound resources are matched to the video frame layer unit of predetermined time according to layout and animation information.

For example, the multimedia content related to one sentence outputted as the caption is played as the video of the frame layer unit interval, and the content synthesis and conversion unit 150 arranges the caption, video, and images on the video of the frame layer unit interval and outputs the sound on predetermined timing. The video resource matching unit 130 matches appropriate content data combination and animation effects and arrangements of the content synthesis and conversion unit 150 to the sentence information, through machine learning, deep learning, and the like.

The matching process will be understood well when referring to FIG. 5. As shown in FIG. 5A, the subject data as text is inputted to the input unit 110, and next, the element information extraction from the subject data is performed through the element information extraction unit 120.

Through the element information extraction, as shown in FIG. 5B, one or more key sentences are extracted as the element information, and as shown in FIG. 5C, the video resource matching unit 130 performs resource content matching of one or more videos, sounds or images stored or linked in the resource database 180 to the extracted element information through the matching process as shown in FIG. 4.

In this case, the resource database 180 is an internal or external database of the service providing apparatus 100 and makes use of resource content service providing servers of well-known service companies.

Further, as shown in FIG. 5D, the multimedia content synthesized and converted through the content synthesis and conversion unit 150 according to the matching information of the video resource matching unit 130 is transmitted to the multimedia content server 300 through the output unit 170 and then distributed and shared to other users.

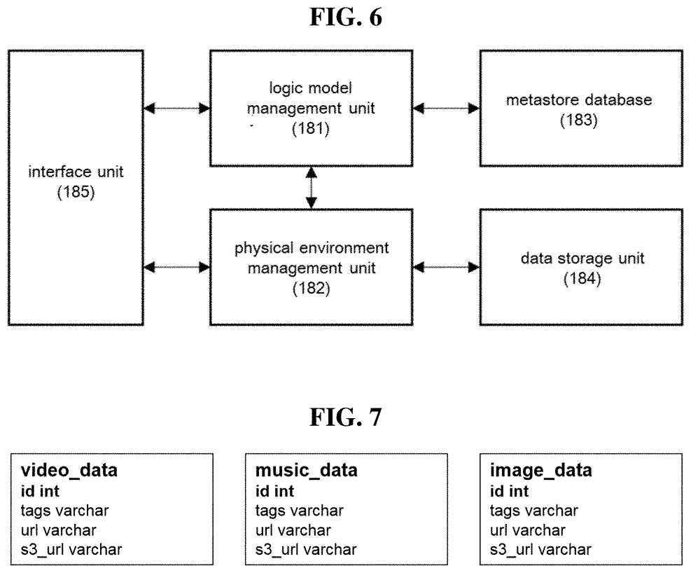

FIGS. 6 and 7 are block diagrams showing resource database according to the present invention.

Referring to FIG. 6, the resource database 180 according to the present invention includes an interface unit 185, a logic model management unit 181, a physical environment management unit 183, a metastore database 183, and a data storage unit 184.

According to the present invention, the resource database 180 classifies and labels metainformation-based media content data, loads the media content data to the form analyzable in the learning database 160, and makes sharing with resource content data easy.

To do this, the resource database 180 performs drop of duplicates, correction of missing data, and detection of abnormal data through the pre-processing of the resource content data, and further, the resource database 180 performs the scaling process of pre-processed data and the data classification for building the learning database 160 using algorithms such as well-known Long Short-Term Memory (LSTM) models.

In specific, the interface unit 185 performs distributed input and output interfacing of the resource content data classified and stored in the respective management units 181 and 182.

The logic model management unit 181 classifies, stores, and manages the resource content through the metastore database 183. In this case, the metastore database 183 stores and manages metadata for indexing big data-based content data of the data storage unit 184 physically stored in the physical environment management unit 182. For example, metadata includes at least one of user classification information, classification information of functions, and storage classification information, and each classification information corresponds to a structure of the data storage unit 184 physically distributed and thus stored.

For example, the data storage unit 184 stores animations, background images, sounds, fonts, and layout information as the resource content.

FIG. 7 is an exemplary view showing stored resource content formats according to the present invention, and the formats include data type information such as video, sound, and image, identification information, tag information, URL information, virtual hosting URL information, and the like.

The metastore database 183 stores and manages metadata as shown in Table 1 as classified information.

TABLE 1

| | | | | |
|---|---|---|---|---|
| Data | Metainfor- | Metainfor- | Metainfor- | |
| Division | mation 1 | mation 2 | mation 3 | Type |

| | | | |
|---|---|---|---|
| Animation | /store | /data | /animation |
| Background | | | /image |
| image | | | |
| Sound | | | /sound |
| Font | | /log | /realtime |
| Layout | | | /batch |
| information | | | |

As shown in Table 1, metainformation are divided by classification information according to data division, and accordingly, the required resources are indexed using the metainformation. Therefore, the resource database 180 according to the present invention manages the data storage unit 184 of the big data structure physically distributed and thus stored and indexes the required resource content using the metainformation of the metastore database 183.

Accordingly, the resource database 180 according to the present invention is built with both the purpose of data storage and the purpose of loading of the stored data in the form to be analyzable and sharing the required data in various analysis environments. Further, the resource database 180 allows SQL-based data information query to be performed to enhance conveniences and rapidness in access to the data.

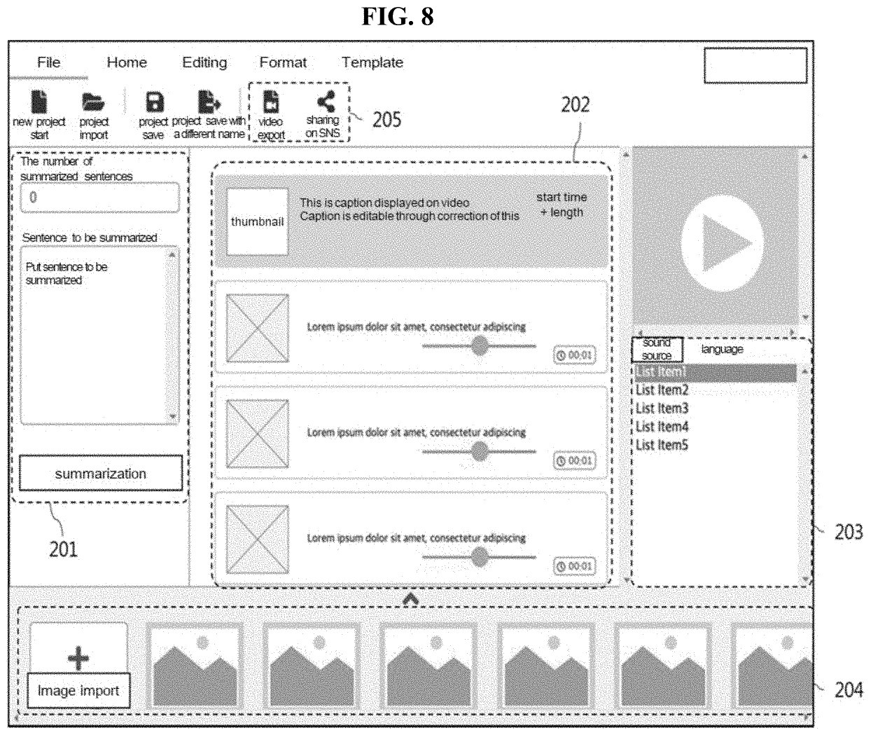

FIG. 8 is an exemplary view showing the production interface according to the present invention.

Referring to FIG. 8, the production interface according to the present invention includes a graphic user interface outputted through the user terminal 200, a subject data input interface 201, a video editing interface 204, a caption editing interface 202, and a sound source editing interface 203.

Further, the service providing apparatus 100 according to the present invention receives text data of a specific document through the subject data input interface 201, and the inputted text data is used for the element information extraction through the element information extraction unit 120 according to the input of a summarization button.

Next, recommended resource content according to the extracted element information-based matching processing of the vide resource matching unit 130 is proposed as recommended items to the video editing interface 204, the caption editing interface 202, and the sound source editing interface 203. After that, the user terminal 200 selects the recommended resource content and thus produces the converted multimedia content.

The user of the user terminal 200 selects the resource content from the respective editing interfaces and inputs video conversion and SNS uploading through an output interface 205. Accordingly, the conversion processing is performed in the content synthesis and conversion unit 150, and the processed result is outputted to the user terminal 200 or uploaded to the multimedia content server 300 so that it can be shared through pre-set SNS accounts.

The method according to the embodiments of the present invention may be made in the form of a program and provided to servers or devices in a state of being stored in a non-transitory computer-readable medium. Accordingly, the user terminal 100 accesses to the servers or devices and downloads the program therefrom.

The non-transitory computer-readable medium stores data semi-permanently, unlike a medium such as register, cache, memory, and the like that stores data for a short period of time, and it is readable by a device. In specific, the above-mentioned various applications or programs may be stored in the non-transitory computer-readable medium such as CD, DVD, hard disc, Blu-ray disc, USB, memory card, ROM, and the like.

While the foregoing examples are illustrative of the principle of the present invention in one or more particular applications, it will be apparent to those or ordinary skill in the art that numerous modifications in form, usage, and details of implementation can be made without the exercise of inventive faculty, and without departing from the principles and concepts of the invention. Accordingly, it is not intended that the invention be limited, except as by the claims set forth below.

1. A method for operating a service providing apparatus, the method comprising the steps of:
receiving subject data to be converted;
extracting element information from the subject data;
performing multimedia content synthesis and conversion based on video resource matching to the element information to acquire converted multimedia content; and
outputting the converted multimedia content.

2. The method according to claim 1, wherein the step of acquiring the converted multimedia content comprises the steps of:
providing a production interface based on the video resource matching to the element information; and
performing the multimedia content synthesis and conversion based on the element information according to user inputs to the production interface.

3. The method according to claim 1, wherein the step of receiving the subject data comprises the steps of:
processing format identification of the subject data; and
assigning format identification information representing types of documents according to the processed format identification.

4. The method according to claim 3, wherein the step of extracting the element information comprises the step of extracting one or more sentence information for the vide resource matching from the subject data based on the format identification information.

5. The method according to claim 4, wherein the step of extracting the sentence information comprises the step of performing a text summarization process of the subject data, and the text summarization process is a process in which different language models determined according to the format identification information of the subject data are used, the language models having extraction model or synthesis model.

6. The method according to claim 1, wherein the video resource matching comprises a process that matches resource content by video frame layer unit divided into given time units to a pre-built resource database, correspondingly to the element information.

7. The method according to claim 6, wherein the resource content comprises at least one of video, background, image, sound, font, and animation matchable to the element information.

8. The method according to claim 1, further comprising the step of sharing the outputted multimedia content with one or more other user terminals through a multimedia content server.

9. A service providing apparatus comprising:
an input unit for receiving subject data to be converted;
an element information extraction unit for extracting element information from the subject data;
a content synthesis and conversion unit for performing multimedia content synthesis and conversion based on video resource matching to the element information to acquire converted multimedia content; and
an output unit for outputting the converted multimedia content.

10. The service providing apparatus according to claim 9, further comprising an interface providing unit for providing a production interface based on the video resource matching to the element information so that the content synthesis and conversion unit performs the multimedia content synthesis and conversion according to user inputs to the production interface and thus acquires the converted multimedia content.

11. The service providing apparatus according to claim 9, wherein the input unit processes format identification of the subject data and assigns format identification information representing types of documents according to the processed format identification.

12. The service providing apparatus according to claim 11, wherein the element information extraction unit extracts one or more sentence information for the vide resource matching from the subject data based on the format identification information.

13. The service providing apparatus according to claim 12, wherein the element information extraction unit performs a text summarization process of the subject data, and the text summarization process is a process in which different language models determined according to the format identification information of the subject data are used, the language models having extraction model or synthesis model.

14. The service providing apparatus according to claim 9, wherein the video resource matching comprises a process that matches resource content by video frame layer unit divided into given time units to a pre-built resource database, correspondingly to the element information.

15. The service providing apparatus according to claim 14, wherein the resource content comprises at least one of video, background, image, sound, font, and animation matchable to the element information.

16. The service providing apparatus according to claim 9, wherein the output unit shares the outputted multimedia content with one or more other user terminals through a multimedia content server.

17. A non-transitory computer-readable recording medium for storing instructions to be executed on a computer, the instructions causing the computer to execute a method comprising the steps of:
receiving subject data to be converted;
extracting element information from the subject data;
performing multimedia content synthesis and conversion based on video resource matching to the element information to acquire converted multimedia content; and
outputting the converted multimedia content.

18. The non-transitory computer-readable recording medium according to claim 17, wherein the step of acquiring the converted multimedia content comprises the steps of:
providing a production interface based on the video resource matching to the element information; and
performing the multimedia content synthesis and conversion based on the element information according to user inputs to the production interface.

19. The non-transitory computer-readable recording medium according to claim 17, wherein the step of receiving the subject data comprises the steps of:
processing format identification of the subject data; and
assigning format identification information representing types of documents according to the processed format identification.

20. The non-transitory computer-readable recording medium according to claim 19, wherein the step of extracting the element information comprises the step of extracting one or more sentence information for the vide resource matching from the subject data based on the format identification information.
